(19) United States
(12) Patent Application Publication
(10) Pub. No.: US 2023/0150162 A1
(43) Pub. Date: May 18, 2023

(54) CUTTER AND CUTTER-HOLDER MATCHING METHOD

(71) Applicant: Zhong Chuan Technology Limited, Taoyuan City (TW)

(72) Inventor: CHAO-HSIN LIN, Taoyuan City (TW)

(21) Appl. No.: 18/096,667

(22) Filed: Jan. 13, 2023

Related U.S. Application Data
(62) Division of application No. 17/485,648, filed on Sep. 27, 2021.

(30) Foreign Application Priority Data
Jun. 16, 2021 (TW) 110121808

(51) Int. Cl. B26D 7/26; B08B 5/02; B08B 3/02

(52) U.S. Cl. CPC B26D 7/2614; B08B 5/023; B08B 3/022

(57) ABSTRACT

A cutter and cutter-holder matching method includes: transferring a cutter holder to a temporary cutter-holder placement module by a first clamping module; heating the cutter holder by a cutter-holder heating module for expanding a cutter clamping hole of the cutter holder; inserting a part of a cutter into the cutter clamping hole of the cutter holder by a second clamping module; cooling the cutter holder by a cutter-holder cooling module for contracting the cutter clamping hole of the cutter holder so as to tightly clamp the cutter; and transferring the cutter holder with the cutter to an assembly storage module by the first clamping module.

### CROSS-REFERENCE TO RELATED PATENT APPLICATION

This application is a divisional application of the U.S. application Ser. No. 17/485,648, filed on Sep. 27, 2021, and entitled “CUTTER AND CUTTER-HOLDER MATCHING SYSTEM AND METHOD,” now pending, the entire disclosures of which are incorporated herein by reference.

### FIELD OF THE DISCLOSURE

The present disclosure relates to a matching method, and more particularly to a cutter and cutter-holder matching method.

### BACKGROUND OF THE DISCLOSURE

In the related art, a cutter and a cutter-holder are matched and assembled manually, so that the conventional method for matching and assembling the cutter and the cutter-holder still has room for improvement.

### SUMMARY OF THE DISCLOSURE

In response to the above-referenced technical inadequacy, the present disclosure provides a cutter and cutter-holder matching method.

In one aspect, the present disclosure provides a cutter and cutter-holder matching method, which includes: transferring a cutter holder to a temporary cutter-holder placement module by a first clamping module; heating the cutter holder by a cutter-holder heating module for expanding a cutter clamping hole of the cutter holder; inserting a part of a cutter into the cutter clamping hole of the cutter holder by a second clamping module; cooling the cutter holder by a cutter-holder cooling module for contracting the cutter clamping hole of the cutter holder so as to tightly clamp the cutter; and transferring the cutter holder with the cutter to an assembly storage module by the first clamping module.

Therefore, in the cutter and cutter-holder matching method provided by the present disclosure, by virtue of “transferring a cutter holder to a temporary cutter-holder placement module by a first clamping module,” “heating the cutter holder by a cutter-holder heating module for expanding a cutter clamping hole of the cutter holder,” “inserting a part of a cutter into the cutter clamping hole of the cutter holder by a second clamping module,” “cooling the cutter holder by a cutter-holder cooling module for contracting the cutter clamping hole of the cutter holder so as to tightly clamp the cutter (for matching the cutter and the cutter holder)” and “transferring the cutter holder with the cutter to an assembly storage module by the first clamping module,” after a corresponding cutter and a corresponding cutter-holder are matched with each other to form the cutter and cutter-holder matching assembly, the cutter and cutter-holder matching assembly including the matched cutter and the matched cutter-holder can be disposed on the assembly storage module.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a functional block diagram of a cutter and cutter-holder matching system according to a first embodiment of the present disclosure;

FIG. 2 is a schematic top view of a carrier module of the cutter and cutter-holder matching system according to the first embodiment of the present disclosure;

FIG. 3 is a schematic side view of a cutter-holder storage module of the cutter and cutter-holder matching system according to the first embodiment of the present disclosure;

FIG. 4 is a schematic side view of a cutter storage module of the cutter and cutter-holder matching system according to the first embodiment of the present disclosure;

FIG. 5 is a schematic side view of a second clamping module of the cutter and cutter-holder matching system clamping a cutter that is exposed from a cutter carrying frame according to the first embodiment of the present disclosure;

FIG. 6 is a step-by-step schematic side view of a temporary cutter placement module of the cutter and cutter-holder matching system in use according to the first embodiment of the present disclosure;

FIG. 7 is a step-by-step schematic side view of a temporary cutter-holder placement module, a cutter-holder heating module, a cutter-holder cooling module, and a cutter and cutter-holder identifying module of the cutter and cutter-holder matching system in use according to the first embodiment of the present disclosure;

FIG. 8 is a schematic side view of an assembly storage module of the cutter and cutter-holder matching system according to the first embodiment of the present disclosure;

FIG. 9 is a schematic side view of the cutter and cutter-holder matching system using a first clamping module to place a cutter and cutter-holder matching assembly on an assembly positioning post that is exposed from the assembly carrying frame according to the first embodiment of the present disclosure;

FIG. 10 is a schematic side view of the cutter and cutter-holder matching system using the cutter-holder heating module and the second clamping module to remove the cutter from a cutter clamping hole of the cutter holder according to the first embodiment of the present disclosure;

FIG. 11 is a schematic side view of the cutter and cutter-holder matching system using a cutter-holder cleaning module according to the first embodiment of the present disclosure;

FIG. 12 is a schematic view of step S100 and step S108 of a cutter and cutter-holder matching system according to a second embodiment of the present disclosure;

FIG. 13 is a schematic view of step S200 and step S206 of the cutter and cutter-holder matching system according to the second embodiment of the present disclosure; and

FIG. 14 is a schematic view of step S300 and step S308 of the cutter and cutter-holder matching system according to the second embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an,” and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

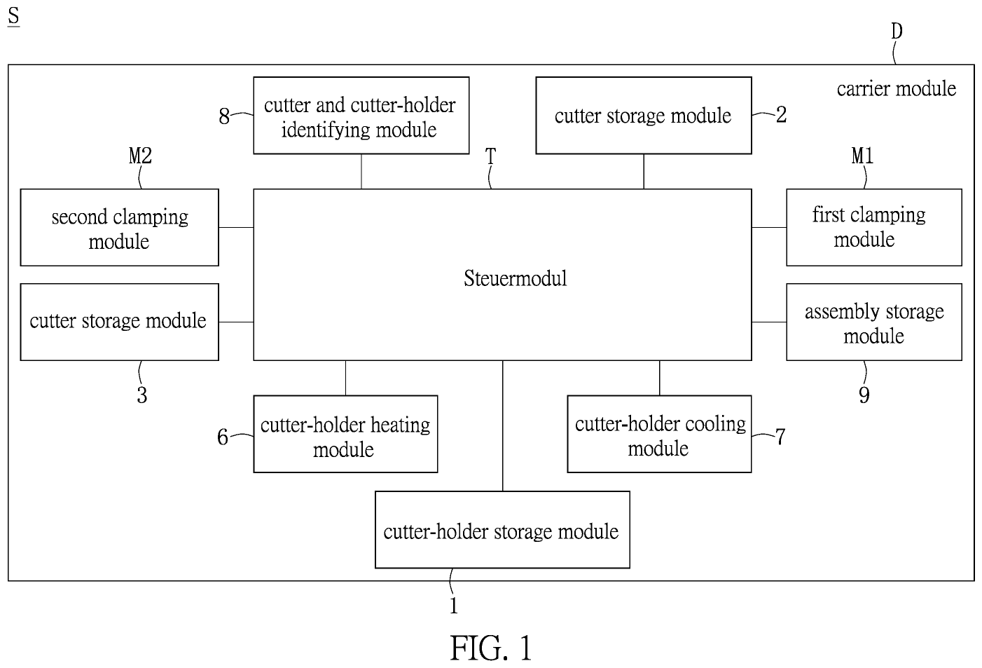

Referring to FIG. 1 to FIG. 14, the present disclosure provides a cutter and cutter-holder matching system S, which at least includes a cutter-holder storage module 1, a cutter storage module 2, a temporary cutter-holder placement module 5, a cutter-holder heating module 6, an assembly storage module 9, a first clamping module M1, and a second clamping module M2. The cutter-holder storage module 1 includes a cutter-holder placement structure 10 configured for carrying a plurality of cutter holders H. The cutter storage module 3 includes a plurality of cutter placement structures 32, and each of the cutter placement structures 32 can be configured for carrying a plurality of cutters C. The temporary cutter-holder placement module 5 includes a temporary cutter-holder placement structure 50 configured for carrying the cutter holder H. The cutter-holder heating module 6 is adjacent to the temporary cutter-holder placement structure 50 and configured for heating the cutter holder H that is carried by the temporary cutter-holder placement structure 50. The assembly storage module 9 includes a plurality of assembly placement structures 92, and each of the assembly placement structures 92 can be configured for carrying a cutter and cutter-holder matching assembly (C-H) that includes the cutter C and the cutter-holder H that are matched with each other. The first clamping module M1 can be configured for transferring the cutter holder H. The second clamping module M2 can be configured for transferring the cutter C. Therefore, a corresponding cutter C and a corresponding cutter-holder H can be matched with each other to form the cutter and cutter-holder matching assembly (C-H), and the cutter and cutter-holder matching assembly (C-H) including the matched cutter C and the matched cutter-holder H can be disposed on the assembly storage module 9.

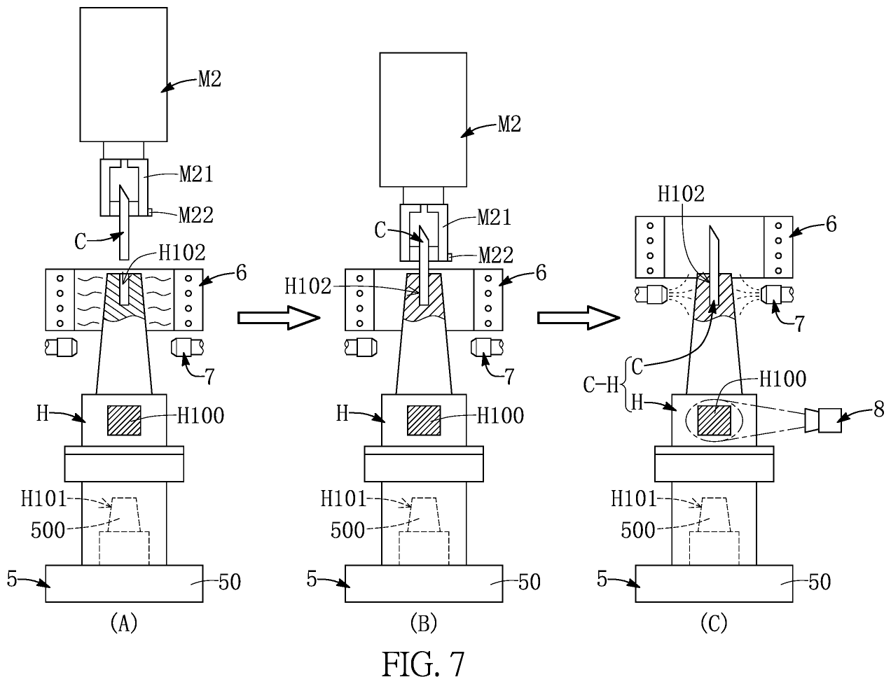

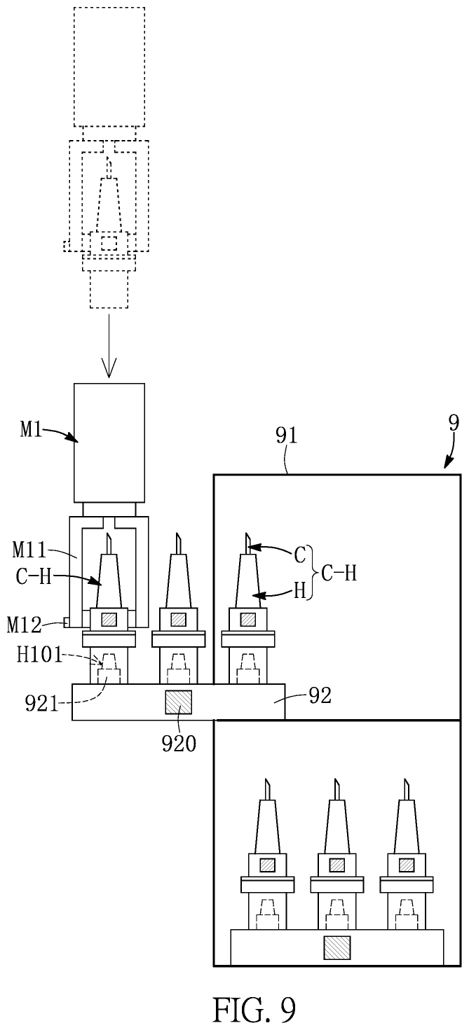

Referring to FIG. 1 to FIG. 14, the present disclosure provides a cutter and cutter-holder matching method, which includes: firstly, as shown in FIG. 7, transferring a cutter holder H to a temporary cutter-holder placement module 5 by a first clamping module M1; next, as shown in step (A) of FIG. 7, heating the cutter holder H by a cutter-holder heating module 6 for expanding a cutter clamping hole H102 of the cutter holder H; then, as shown in step (B) of FIG. 7, inserting a part of a cutter C into the cutter clamping hole H102 of the cutter holder H by a second clamping module M2; afterward, as shown in step (C) of FIG. 7, cooling the cutter holder H by a cutter-holder cooling module 7 for contracting the cutter clamping hole H102 of the cutter holder H so as to tightly clamp the cutter C; then, as shown in FIG. 9, transferring the cutter holder H with the cutter C to an assembly storage module 9 by the first clamping module M1. Therefore, a corresponding cutter C and a corresponding cutter-holder H can be matched with each other to form the cutter and cutter-holder matching assembly (C-H), and the cutter and cutter-holder matching assembly (C-H) including the matched cutter C and the matched cutter-holder H can be disposed on the assembly storage module 9.

### First Embodiment

Referring to FIG. 1 to FIG. 11, a first embodiment of the present disclosure provides a cutter and cutter-holder matching system S, which includes a cutter-holder storage module 1, a cutter-holder cleaning module 2, a cutter storage module 3, a temporary cutter placement module 4, a temporary cutter-holder placement module 5, a cutter-holder heating module 6, a cutter-holder cooling module 7, a cutter and cutter-holder identifying module 8, an assembly storage module 9, a first clamping module M1, and a second clamping module M2.

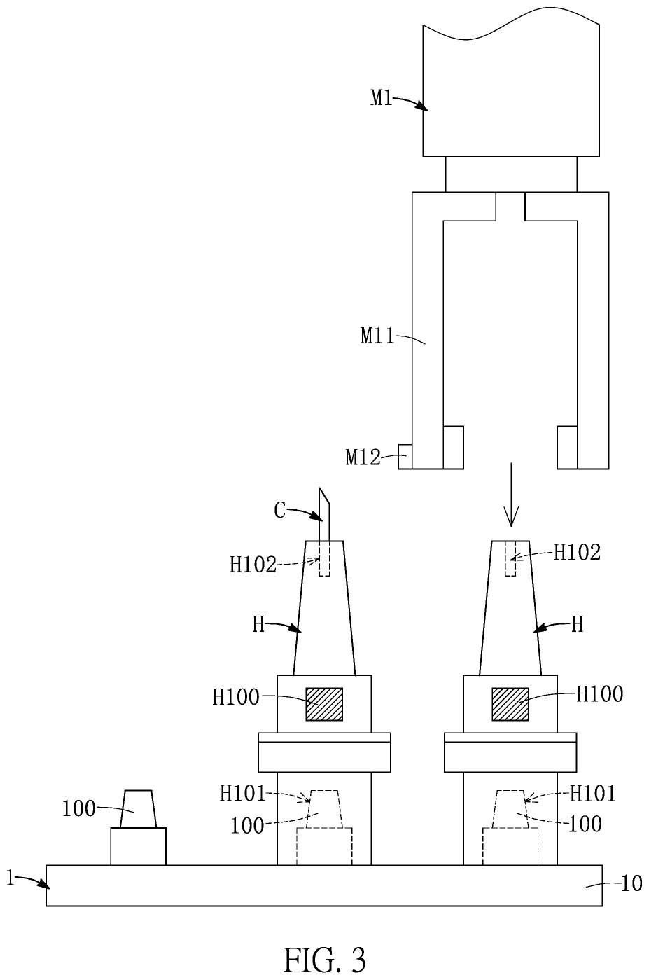

More particularly, as shown in FIG. 3, the cutter-holder storage module 1 includes a cutter-holder placement structure 10 that can be configured for carrying a plurality of cutter holders H. For example, the cutter holder H has a cutter-holder positioning groove H101 disposed on a bottom portion thereof, the cutter-holder placement structure 10 includes a plurality of cutter-holder positioning posts 100, and the cutter holder H can be disposed (positioned) on the cutter-holder placement structure 10 by matching the cutter-holder positioning groove H101 and the cutter-holder positioning post 100 (such as by matching a shape of the cutter-holder positioning groove H101 and a shape of the cutter-holder positioning post 100). It should be noted that each of the cutter holders H has an identifiable cutter-holder code H100 (such as a text, a pattern or a barcode), and at least two of the identifiable cutter-holder codes H100 of the cutter holders H are different from each other (or all of the identifiable cutter-holder codes H100 of the cutter holders H are different from each other). However, the aforementioned description is merely an example, and is not meant to limit the scope of the present disclosure.

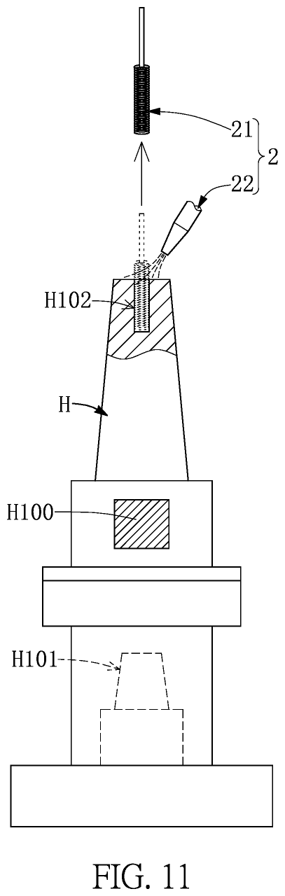

More particularly, referring to FIG. 3 and FIG. 11, the cutter-holder cleaning module 2 includes a cleaning tool 21 that can be configured for cleaning the cutter holder H, and a blowing tool 22 that can be configured for drying the cutter holder H that has been cleaned by the cleaning tool 21. For example, the cutter holder H has a cutter clamping hole H102, the cutter clamping hole H102 of the cutter holder H can be cleaned by cooperation of the cleaning tool 21 and a cleaning agent (such as by cooperation of a brush and oil cleaning liquid or any type of decontaminating agent), and the cutter clamping hole H102 of the cutter holder H can be dried by the blowing tool 22 after the cutter clamping hole H102 of the cutter holder H has been cleaned. That is to say, after the cutter C is removed from the cutter clamping hole H102 of the cutter holder H, the cutter clamping hole H102 of the cutter holder H can be cleaned by cooperation of the cleaning tool 21 and the cleaning agent, and then the cutter clamping hole H102 of the cutter holder H can be dried by the blowing tool 22 (at this moment, the cleaning tool 21 has been removed from the cutter clamping hole H102 of the cutter holder H). However, the aforementioned description is merely an example, and is not meant to limit the scope of the present disclosure.

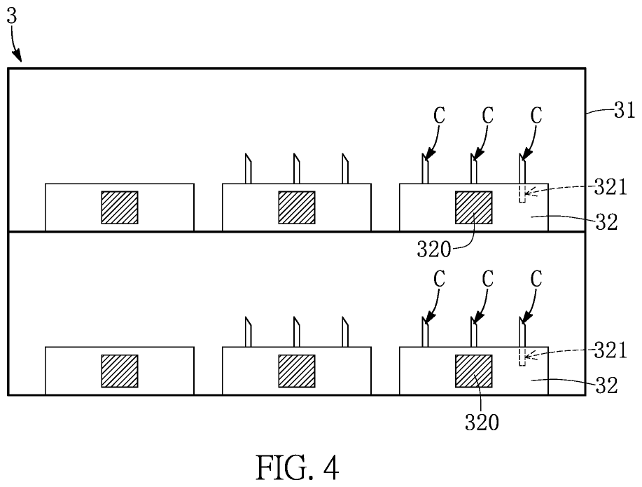

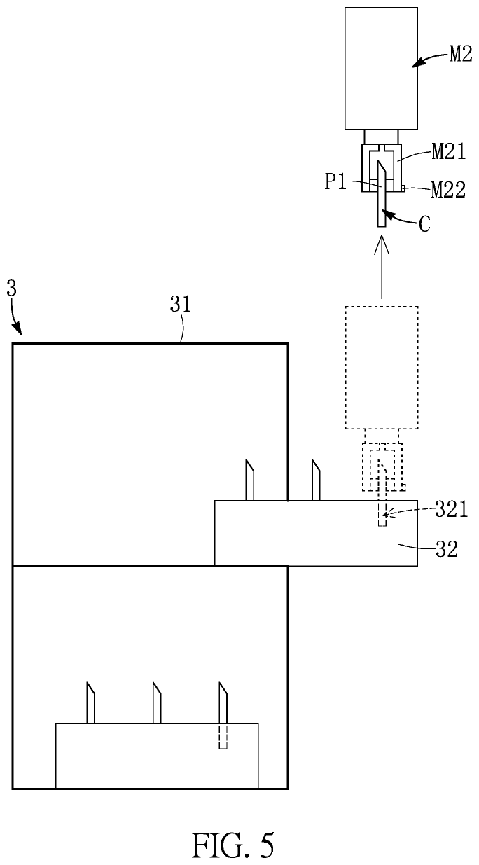

More particularly, referring to FIG. 4 and FIG. 5, the cutter storage module 3 includes a cutter carrying frame 31 and a plurality of cutter placement structures 32 movably disposed on the cutter carrying frame 31, and each of the cutter placement structures 32 is configured for carrying a plurality of cutters C. For example, each of the cutter placement structures 32 has a plurality of cutter placement holes 321, and the cutter C can be partially received inside a corresponding one of the cutter placement holes 321. In addition, as shown in FIG. 5, when the cutter placement structure 32 is configured to be horizontally moved relative to the cutter carrying frame 31 so as to expose the cutter C from the cutter carrying frame 31, the second clamping module M2 can be configured to be vertically moved so as to clamp the cutter C that is exposed from the cutter carrying frame 31. It should be noted that each of the cutter placement structures 32 has an identifiable cutter code 320 (such as a text, a pattern or a barcode) corresponding to a corresponding one of the cutters C, and at least two of the identifiable cutter codes 320 of the cutter placement structures 32 are different from each other (or all of the identifiable cutter codes 320 of the cutter placement structures 32 are different from each other). However, the aforementioned description is merely an example, and is not meant to limit the scope of the present disclosure.

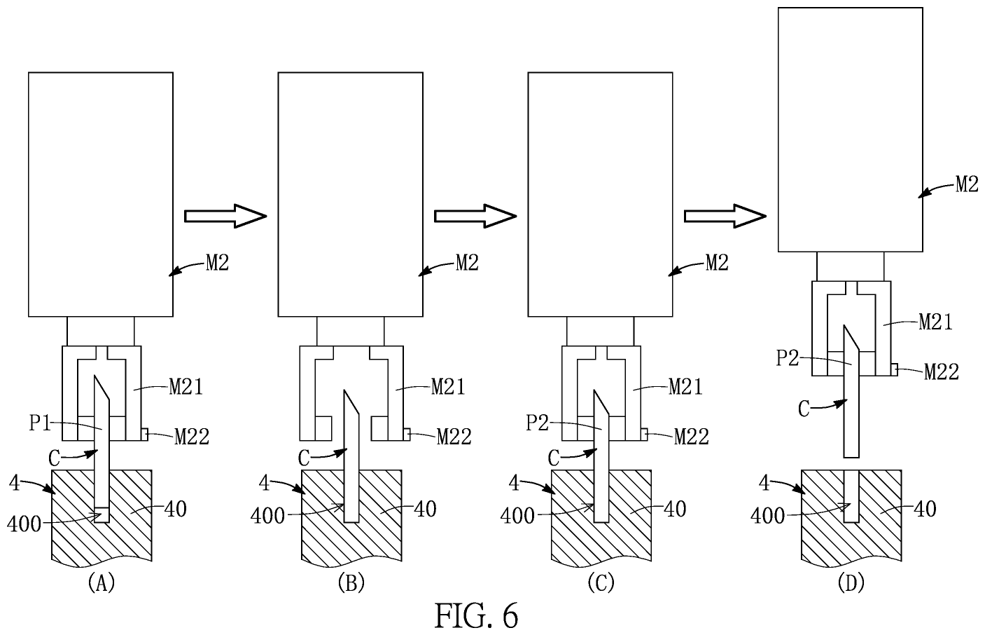

More particularly, referring to FIG. 5 and FIG. 6, the temporary cutter placement module 4 includes a temporary cutter placement structure 40 configured for carrying the cutter C, and the temporary cutter placement structure 40 has a cutter receiving groove 400 for partially receiving the cutter C. For example, the cutter C can be transferred from the cutter placement structure 32 to the temporary cutter placement structure 40 by the second clamping module M2, and the cutter C can be removed from the cutter receiving groove 400 of the temporary cutter placement structure 40 by the second clamping module M2. However, the aforementioned description is merely an example, and is not meant to limit the scope of the present disclosure.

More particularly, as shown in FIG. 7, the temporary cutter-holder placement module 5 includes a temporary cutter-holder placement structure 50 configured for carrying the cutter holder H, and the cutter-holder heating module 6 is adjacent to the temporary cutter-holder placement structure 50 and configured for heating the cutter holder H that is carried by the temporary cutter-holder placement structure 50. For example, when the cutter holder H is disposed on a temporary cutter-holder positioning post 500 of the temporary cutter-holder placement structure 50 (by matching the cutter-holder positioning groove H101 and temporary cutter-holder positioning post 500), the cutter-holder heating module 6 can be configured for surrounding and heating the cutter holder H (as shown in step (A) of FIG. 7) so as to expand a cutter clamping hole H102 of the cutter holder H, so that the cutter C can be allowed to be partially received in the cutter clamping hole H102 of the cutter holder H (as shown in step (B) of FIG. 7). However, the aforementioned description is merely an example, and is not meant to limit the scope of the present disclosure.

More particularly, as shown in FIG. 7, the cutter-holder cooling module 7 is adjacent to the temporary cutter-holder placement structure 50 and configured for cooling the cutter holder H that is carried by the temporary cutter-holder placement structure 50. For example, as shown in step (C) of FIG. 7, after the cutter clamping hole H102 of the cutter holder H is expanded by heating of the cutter-holder heating module 6 so as to allow the cutter C to be partially received in the cutter clamping hole H102 of the cutter holder H, the cutter-holder cooling module 7 can be configured for surrounding and cooling the cutter holder H (such as blowing the cutter holder H by the cutter-holder cooling module 7) so as to contract the cutter clamping hole H102 of the cutter holder H, so that the cutter C can be allowed to be tightly clamped by the cutter clamping hole H102 of the cutter holder H. However, the aforementioned description is merely an example, and is not meant to limit the scope of the present disclosure.

More particularly, as shown in FIG. 3, FIG. 4 and FIG. 7, the cutter and cutter-holder identifying module 8 is adjacent to the temporary cutter-holder placement structure 50 and configured for capturing information of a cutter and cutter-holder matching assembly (C-H) that includes the cutter C and the cutter-holder H, and for identifying whether or not the cutter C and the cutter holder H of the cutter and cutter-holder matching assembly (C-H) are matched with each other. For example, for each of the cutter and cutter-holder matching assemblies (C-H) (as shown in step (C) of FIG. 7), the identifiable cutter-holder code H100 of the cutter holder H (as shown in FIG. 3) and the identifiable cutter code 320 that corresponds to the corresponding one of the cutters C (as shown in FIG. 4) can be matched with each other, and the cutter and cutter-holder identifying module 8 can be configured to know whether the identifiable cutter-holder code H100 and the identifiable cutter code 320 are matched by identifying the identifiable cutter-holder code H100 of the cutter and cutter-holder matching assembly (C-H). However, the aforementioned description is merely an example, and is not meant to limit the scope of the present disclosure.

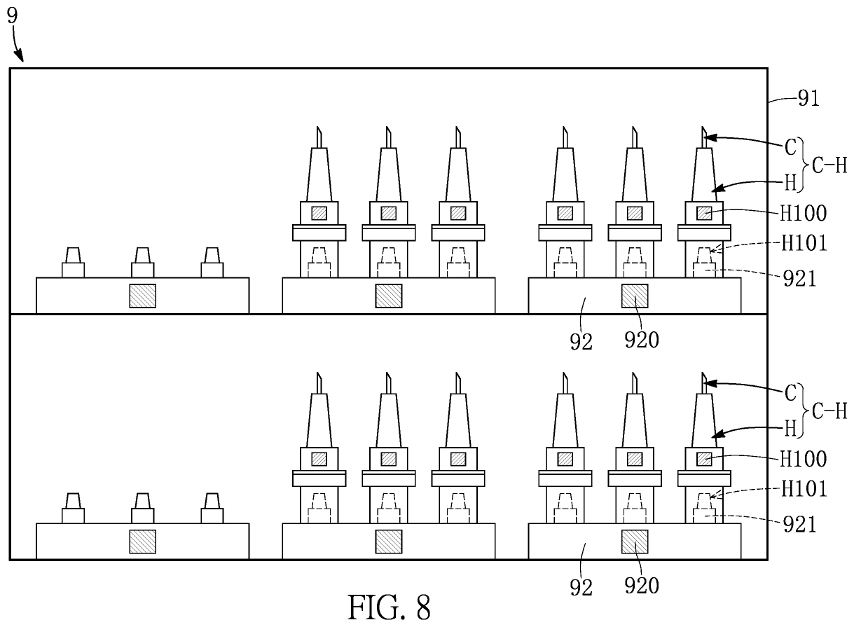

More particularly, as shown in FIG. 8 and FIG. 9, the assembly storage module 9 includes an assembly carrying frame 91 and a plurality of assembly placement structures 92 movably disposed on the assembly carrying frame 91, and each of the assembly placement structures 92 can be configured for carrying the cutter and cutter-holder matching assembly (C-H). For example, as shown in FIG. 9, when the assembly placement structure 92 is configured to be horizontally moved relative to the assembly carrying frame 91 so as to expose a plurality of assembly positioning posts 921 of the assembly placement structure 92 from the assembly carrying frame 91, the first clamping module M1 can be configured to be vertically moved so as to place the cutter and cutter-holder matching assembly (C-H) on the assembly positioning post 921 that is exposed from the assembly carrying frame 91. In addition, each of the assembly placement structures 92 has a plurality of assembly positioning posts 921, and the cutter and cutter-holder matching assembly (C-H) can be disposed on the assembly placement structure 92 by matching the cutter-holder positioning groove H101 and the assembly positioning post 921. It should be noted that each of the assembly placement structures 92 has an identifiable assembly code 920 (such as a text, a pattern or a barcode) corresponding to the identifiable cutter-holder code H100, and at least two of the identifiable assembly codes 920 of the assembly placement structures 92 are different from each other (or all of the identifiable assembly codes 920 of the assembly placement structures 92 are different from each other). However, the aforementioned description is merely an example, and is not meant to limit the scope of the present disclosure.

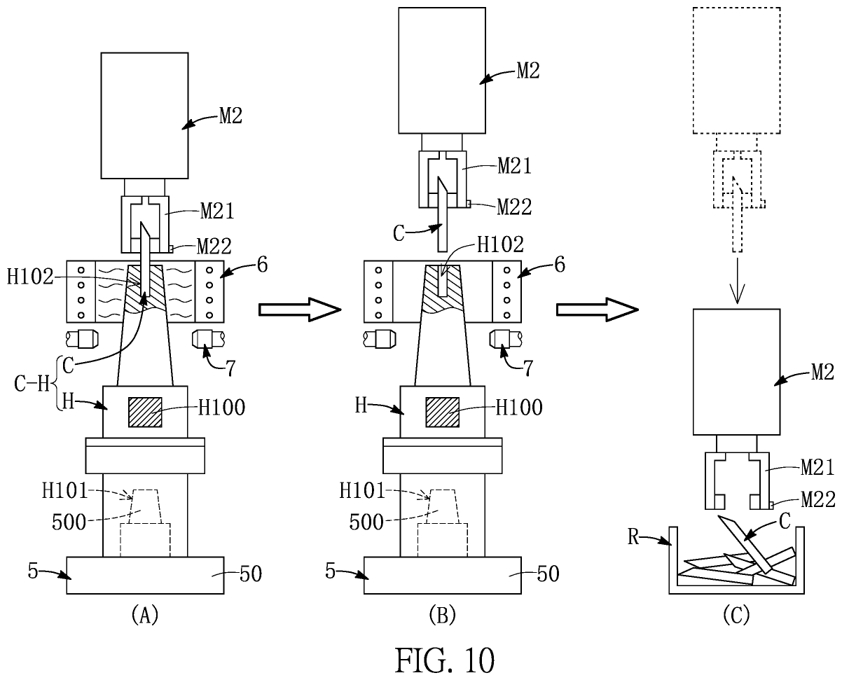

More particularly, as shown in FIG. 7, FIG. 9, FIG. 10 and FIG. 11, the first clamping module M1 can be configured for transferring the cutter holder H between any two of the cutter-holder placement structures 10, the cutter-holder cleaning module 2, the temporary cutter-holder placement structure 50, and the assembly placement structure 92. For example, the first clamping module M1 can be configured for transferring the cutter holder H from the cutter-holder placement structure 10 to the cutter-holder cleaning module 2 (as shown in FIG. 11), for transferring the cutter holder H from the cutter-holder cleaning module 2 to the temporary cutter-holder placement structure 50 (as shown in FIG. 7), for transferring the cutter holder H from the temporary cutter-holder placement structure 50 to the cutter-holder cleaning module 2 (as shown in FIG. 11), for transferring the cutter holder H from the cutter-holder placement structure 10 to the temporary cutter-holder placement structure 50 (as shown in FIG. 10), or for transferring the cutter holder H from the temporary cutter-holder placement structure 50 to the assembly placement structure 92 (as shown in FIG. 9). In addition, the first clamping module M1 includes a first gripper jaw M11, and a first distance sensor M12 disposed on the first gripper jaw M11 for measuring a height of an exposed portion (being exposed from the cutter holder H) of the cutter C that is clamped by the cutter holder H (as shown in step (C) of FIG. 7). However, the aforementioned description is merely an example, and is not meant to limit the scope of the present disclosure.

More particularly, as shown in FIG. 6, FIG. 7 and FIG. 10, the second clamping module M2 can be configured for transferring the cutter C between any two of the cutter placement structures 32, the temporary cutter placement structure 40, and the temporary cutter-holder placement structure 50. For example, the second clamping module M2 can be configured for transferring the cutter from the cutter placement structure 32 to the temporary cutter placement structure 40 (as shown in FIG. 6), for transferring the cutter from the temporary cutter placement structure 40 to the temporary cutter-holder placement structure 50 (as shown in FIG. 7 and FIG. 10), or for transferring the cutter from the cutter placement structure 32 to the temporary cutter-holder placement structure 50 (as shown in FIG. 7 and FIG. 10). In addition, the second clamping module M2 includes a second gripper jaw M21, and a second distance sensor M22 disposed on the second gripper jaw M21 for measuring a height of another exposed portion (being exposed from the cutter receiving groove 400) of the cutter C that is received in the cutter receiving groove 400 (as shown in step (B) of FIG. 6). However, the aforementioned description is merely an example, and is not meant to limit the scope of the present disclosure.

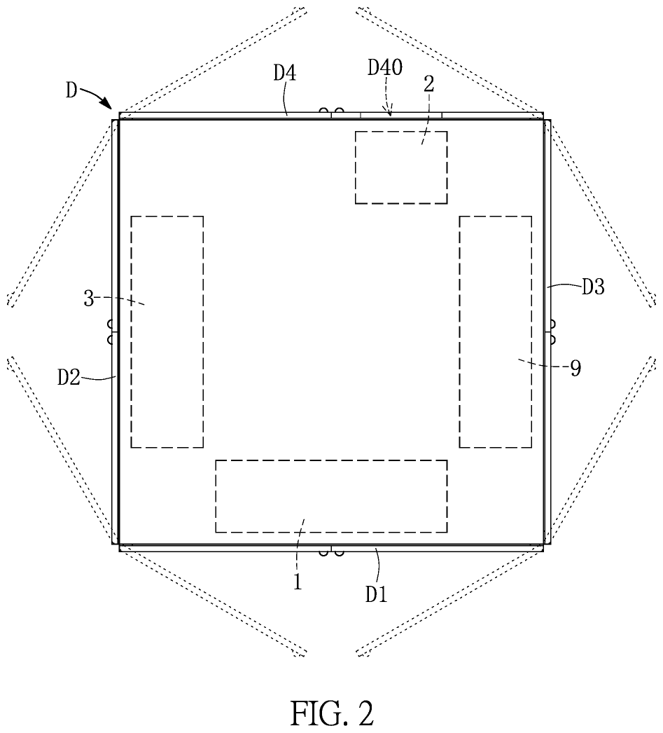

For example, referring to FIG. 1 and FIG. 2, the cutter and cutter-holder matching system S of the first embodiment further of the present disclosure includes a control module T and a carrier module D. More particularly, the control module T is electrically connected to the cutter-holder heating module 6 and configured for recording a number of times a same one of the cutter holders H is heated by the cutter-holder heating module 6 (that is, to record a useful life of the cutter holder H for stably clamping the cutter C). In addition, the carrier module D includes a first openable door D1 corresponding to the cutter-holder storage module 1, a second openable door D2 corresponding to the cutter storage module 3, a third openable door D3 corresponding to the assembly storage module 9, and a fourth openable door D4 corresponding to the cutter-holder cleaning module 2. However, the aforementioned description is merely an example, and is not meant to limit the scope of the present disclosure.

For example, referring to FIG. 2 and FIG. 3, when the first openable door D1 is opened, the cutter holder H can be transferred from a first predetermined region out of the carrier module D onto the cutter-holder placement structure 10 through the first openable door D1, or the cutter holder H can be transferred from the cutter-holder placement structure 10 to the first predetermined region out of the carrier module D through the first openable door D1. In addition, referring to FIG. 2 and FIG. 4, when the second openable door D2 is opened, the cutter C can be transferred from a second predetermined region out of the carrier module D onto the cutter placement structure 32 through the second openable door D2, or the cutter C can be transferred from the cutter placement structure 32 to the second predetermined region out of the carrier module D through the second openable door D2. Moreover, referring to FIG. 2 and FIG. 8, when the third openable door D3 is opened, the cutter and cutter-holder matching assembly (C-H) can be transferred from a third predetermined region out of the carrier module D onto the assembly placement structure 92 through the third openable door D3, or the cutter and cutter-holder matching assembly (C-H) can be transferred from the assembly placement structure 92 to the third predetermined region out of the carrier module D through the third openable door D3. Furthermore, referring to FIG. 2 and FIG. 11, when the fourth openable door D4 is closed, a vent D40 of the fourth openable door D4 can be configured for discharging an odor (such as the smell of oil) that is generated by using the cutter-holder cleaning module 2 to clean the cutter holder H. However, the aforementioned description is merely an example, and is not meant to limit the scope of the present disclosure.

### Second Embodiment

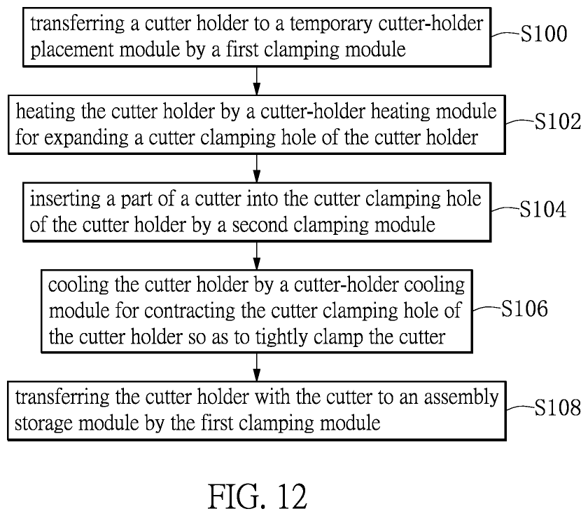

Referring to FIG. 3, FIG. 7, FIG. 9 and FIG. 12, a second embodiment of the present disclosure provides a cutter and cutter-holder matching method, which includes: firstly, referring to FIG. 3, FIG. 7 and FIG. 12, transferring a cutter holder H to a temporary cutter-holder placement module 5 by a first clamping module M1 (step S100); next, referring to step (A) of FIG. 7 and FIG. 12, heating the cutter holder H by a cutter-holder heating module 6 for expanding a cutter clamping hole H102 of the cutter holder H (step S102); then, referring to step (B) of FIG. 7 and FIG. 12, inserting a part of a cutter C into the cutter clamping hole H102 of the cutter holder H by a second clamping module M2 (step S104); afterward, referring to step (C) of FIG. 7 and FIG. 12, cooling the cutter holder H by a cutter-holder cooling module 7 for contracting the cutter clamping hole H102 of the cutter holder H so as to tightly clamp the cutter C (step S106); then, referring to FIG. 9 and FIG. 12, transferring the cutter holder H with the cutter C to an assembly storage module 9 by the first clamping module M1 (step S108). Therefore, a corresponding cutter C and a corresponding cutter-holder H can be matched with each other to form the cutter and cutter-holder matching assembly (C-H), and the cutter and cutter-holder matching assembly (C-H) including the matched cutter C and the matched cutter-holder H can be disposed on the assembly storage module 9.

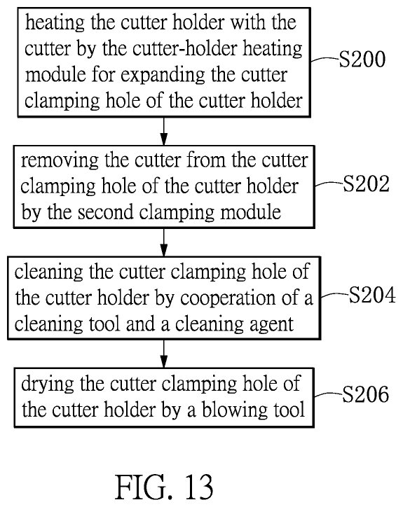

More particularly, referring to FIG. 10, FIG. 11 and FIG. 13, the cutter and cutter-holder matching method of the second embodiment of the present disclosure further includes: firstly, referring to step (A) of FIG. 10 and FIG. 13, heating the cutter holder H with the cutter C by the cutter-holder heating module 6 for expanding the cutter clamping hole H102 of the cutter holder H (step S200); next, referring to step (B) and step (C) of FIG. 10 and FIG. 13, removing the cutter C from the cutter clamping hole H102 of the cutter holder H by the second clamping module M2 (step S202); then, referring to FIG. 11 and FIG. 13, cleaning the cutter clamping hole H102 of the cutter holder H by cooperation of a cleaning tool 21 and a cleaning agent (step S204); afterward, referring to FIG. 11 and FIG. 13, drying the cutter clamping hole H102 of the cutter holder H by a blowing tool 22 (step S206).

It should be noted that as shown in FIG. 1, a number of times that the cutter holders H can be heated by the cutter-holder heating module 6 can be recorded by a control module T. That is to say, the control module T can be electrically connected to the cutter-holder heating module 6 so as to record a number of times a same one of the cutter holders H is heated by the cutter-holder heating module 6 (that is to record a useful life of the cutter holder H for stably clamping the cutter C).

It should be noted that as shown in FIG. 10, after the cutter C is removed from the cutter clamping hole H102 of the cutter holder H, the cutter C of the cutter and cutter-holder matching assembly (C-H) can be transferred to a tool disposal region R by the second clamping module M2. For example, when the cutter and cutter-holder matching assembly (C-H) is disposed on the temporary cutter-holder positioning post 500 of the assembly placement structure 92, the cutter-holder heating module 6 can be configured for surrounding and heating the cutter holder H of the cutter and cutter-holder matching assembly (C-H) (as shown in step (A) of FIG. 10) so as to expand a cutter clamping hole H102 of the cutter holder H of the cutter and cutter-holder matching assembly (C-H), so that the cutter C of the cutter and cutter-holder matching assembly (C-H) can be allowed to be transferred from the cutter clamping hole H102 to a tool disposal region R by the second clamping module M2 (as shown in step (B) and step (C) of FIG. 10).

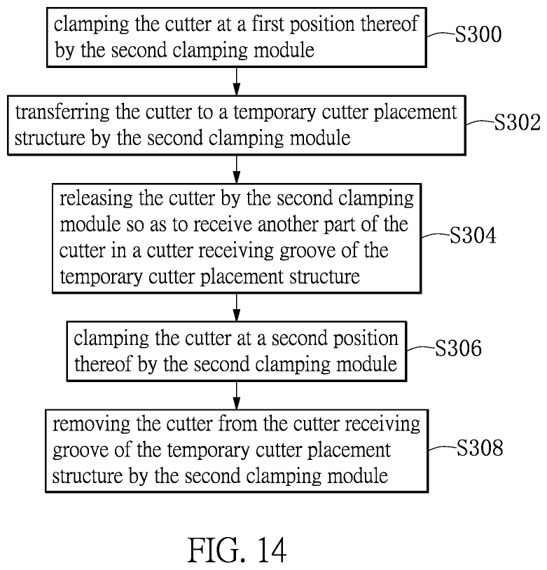

More particularly, referring to FIG. 5, FIG. 6 and FIG. 14, before inserting the part of the cutter C into the cutter clamping hole H102 of the cutter holder H by the second clamping module M2, the cutter and cutter-holder matching method further includes: firstly, referring to FIG. 5 and FIG. 14, clamping the cutter C at a first position P1 thereof by the second clamping module M2 (step S300); next, referring to step (A) of FIG. 6 and FIG. 14, transferring the cutter C to a temporary cutter placement structure 40 by the second clamping module M2 (step S302); then, referring to step (B) of FIG. 6 and FIG. 14, releasing the cutter C by the second clamping module M2 so as to receive another part of the cutter C in a cutter receiving groove 400 of the temporary cutter placement structure 40 (step S304); afterward, referring to step (C) of FIG. 6 and FIG. 14, clamping the cutter C at a second position P2 thereof by the second clamping module M2 (step S306); next, referring to step (D) of FIG. 6 and FIG. 14, removing the cutter C from the cutter receiving groove 400 of the temporary cutter placement structure 40 by the second clamping module M2 (step S308). Therefore, the clamping position of the cutter C that is clamped by the second clamping module M2 can be adjusted (or unified) by using the temporary cutter placement structure 40. It should be noted that the first position P1 and the second position P2 of the cutter C either overlap with each other, or do not overlap with each other.

### Beneficial Effects of the Embodiments

In conclusion, Therefore, in the cutter and cutter-holder matching system S provided by the present disclosure, by virtue of “the cutter-holder storage module 1 including a cutter-holder placement structure 10 configured for carrying a plurality of cutter holders H,” “the cutter storage module 3 including a plurality of cutter placement structures 32 each being configured for carrying a plurality of cutters C,” “the temporary cutter-holder placement module 5 including a temporary cutter-holder placement structure 50 configured for carrying the cutter holder H,” “the cutter-holder heating module 6 being adjacent to the temporary cutter-holder placement structure 50 and configured for heating the cutter holder H that is carried by the temporary cutter-holder placement structure 50,” “the assembly storage module 9 including a plurality of assembly placement structures 92 each being configured for carrying a cutter and cutter-holder matching assembly (C-H) that includes the cutter C and the cutter holder H that are matched with each other,” “the first clamping module M1 being configured for transferring the cutter holder H” and “the second clamping module M2 being configured for transferring the cutter C,” after a corresponding cutter C and a corresponding cutter-holder H are matched with each other to form the cutter and cutter-holder matching assembly (C-H), the cutter and cutter-holder matching assembly (C-H) including the matched cutter C and the matched cutter-holder H can be disposed on one of the assembly placement structures 92 of the assembly storage module 9.

Furthermore, in the cutter and cutter-holder matching method provided by the present disclosure, by virtue of “transferring a cutter holder H to a temporary cutter-holder placement module 5 by a first clamping module M1,” “heating the cutter holder H by a cutter-holder heating module 6 for expanding a cutter clamping hole H102 of the cutter holder H,” “inserting a part of a cutter C into the cutter clamping hole H102 of the cutter holder H by a second clamping module M2,” “cooling the cutter holder H by a cutter-holder cooling module 7 for contracting the cutter clamping hole H102 of the cutter holder H so as to tightly clamp the cutter C (for matching the cutter C and the cutter holder H)” and “transferring the cutter holder H with the cutter C to an assembly storage module 9 by the first clamping module M1,” after a corresponding cutter C and a corresponding cutter-holder H are matched with each other to form the cutter and cutter-holder matching assembly (C-H), the cutter and cutter-holder matching assembly (C-H) including the matched cutter C and the matched cutter-holder H can be disposed on the assembly storage module 9.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A cutter and cutter-holder matching method, comprising:
transferring a cutter holder to a temporary cutter-holder placement module by a first clamping module;
heating the cutter holder by a cutter-holder heating module for expanding a cutter clamping hole of the cutter holder;
inserting a part of a cutter into the cutter clamping hole of the cutter holder by a second clamping module;
cooling the cutter holder by a cutter-holder cooling module for contracting the cutter clamping hole of the cutter holder so as to tightly clamp the cutter; and
transferring the cutter holder with the cutter to an assembly storage module by the first clamping module.

2. The cutter and cutter-holder matching method according to claim 1, further comprising:
heating the cutter holder with the cutter by the cutter-holder heating module for expanding the cutter clamping hole of the cutter holder;
removing the cutter from the cutter clamping hole of the cutter holder by the second clamping module;
cleaning the cutter clamping hole of the cutter holder by cooperation of a cleaning tool and a cleaning agent; and
drying the cutter clamping hole of the cutter holder by a blowing tool.

3. The cutter and cutter-holder matching method according to claim 2, wherein a control module is configured for recording a number of times a same one of the cutter holders is heated by the cutter-holder heating module.

4. The cutter and cutter-holder matching method according to claim 3, wherein, before inserting the part of the cutter into the cutter clamping hole of the cutter holder by the second clamping module, the cutter and cutter-holder matching method comprises:
clamping the cutter at a first position thereof by the second clamping module;
transferring the cutter to a temporary cutter placement structure by the second clamping module;
releasing the cutter by the second clamping module so as to receive another part of the cutter in a cutter receiving groove of the temporary cutter placement structure;
clamping the cutter at a second position thereof by the second clamping module; and
removing the cutter from the cutter receiving groove of the temporary cutter placement structure by the second clamping module.
